(19) United States
(12) Patent Application Publication
(10) Pub. No.: US 2024/0274911 A1
(43) Pub. Date: Aug. 15, 2024

(54) LEADED SLAG CLEANING AND RECOVERY OF USEFUL METALS AND REUSE OF SLAG

(71) Applicant: GOPHER RESOURCE, LLC, Eagan, MN (US)

(72) Inventors: Joseph GROGAN, Eagan, MN (US); Daniel GRAF, Tampa, FL (US)

(21) Appl. No.: 18/431,129

(22) Filed: Feb. 2, 2024

Related U.S. Application Data
(60) Provisional application No. 63/443,009, filed on Feb. 2, 2023.

(51) Int. Cl. H01M 10/54; C22B 3/00; C22B 7/04; C22B 26/10

(52) U.S. Cl. CPC H01M 10/54; C22B 7/04; C22B 13/045; C22B 25/04; C22B 26/10

(57) ABSTRACT

A system and method for recovering heavy metals from nonhazardous scrap lead acid battery slag using pyrometallurgical and hydrometallurgical process to clean slag for commercial use as an environmentally friendly substitute solid filler in product. Process recovers previously nonhazardous landfilled lead and tin for value economically for the business unit and repurposes the businesses major solid waste stream. Methods iteratively remove tin, lead, antimony, arsenic from slag to be used in commercial materials as well as concentrate lead and tin in a fume to recover lead for recycled production and produce commercial grade tin.

### CROSS-REFERENCE TO RELATED APPLICATION

The present application claims priority under 35 U.S.C. § 119 to U.S. Provisional Application No. 63/443,009 entitled “LEADED SLAG CLEANING AND RECOVERY OF USEFUL METALS AND REUSE OF SLAG,” filed on Feb. 2, 2023, which is hereby incorporated by reference herein in its entirety for all intents and purposes.

### FIELD

The disclosed process, methods, and systems are directed to lead acid battery recycling. As disclosed herein, slags from lead acid recycling are processed to separate useful metals (e.g. lead, tin, antimony, and arsenic) and produce a cleaner slag with desirable properties. The processed slag, as disclosed herein, can be used in various ways and incorporated into various products. In one example, the disclosed processed slag may be used as a solid waste substitute filler in commercial products. In another example the processed slag may be used in environmental remediation. In some cases, the disclosed processes, methods, and systems may be referred to as SCRUM—Slag Cleaning and Recovery of Useful Metals. The disclosed SCRUM process may, in many cases, be used to recover all or nearly all Pb, Sn, Sb, and As in secondary lead acid battery waste slag.

### BACKGROUND

Lead acid batteries are recycled at a rate greater than 99% or 2.52 million tons of batteries per year in the United States of America, roughly translating to 140,000 tons per year of nonhazardous slag discarded as tailings on larger sites or to landfills on smaller sites. Recycling processes vary, but all result in a slag byproduct. This slag, which may be referred to as Lead Blast Furnace slag or LBF slag, is required to pass an EPA Toxicity Characteristic Leaching Procedure (TCLP) for nonhazardous disposal. However, without proper cleansing, the LBF slag cannot be industrialized due to the leachability of metals subject to the Resource Conservation and Recovery Act (RCRA). The presence of RCRA metals in the LBF slag, even if it were to pass EPA toxicity tests, as well as other undesirable elements (for example sulfur), also prevent beneficial use of LBF slag. Additionally, LBF slag contains significant amounts of sodium, which co-mingles with and contaminates lead- and tin-containing fume making it economically difficult or impossible to recover these marketable materials. Thus, LBF slag is sent to landfills.

Recovery of the low concentrations of valuable metals present in LBF slag and/or removal of unfavorable metals may help to reduce the amount LBF slag sent to landfills and instead diverted to higher value uses. However, such processing is not, at present, economically feasible. What is needed are processes and systems for recovering valuable metals, removing regulated metals, and producing a valuable end product from LBF slag. Such processes and systems would encompass the principles of the circular economy which represent multiple advantages over the existing landfilling, for example decarbonization, reduced solid waste footprints, and preservation of finite resources.

### SUMMARY

Disclosed herein are processes and systems useful for recovering valuable metals from a lead acid battery recycling (Lead Blast Furnace or LBF) slag, also referred to herein as silica-sodium-lead slag, removing unwanted elements, and providing commercializable waste for product manufacturing in other industrial sectors. The disclosed processes and systems, in most cases, use hydrometallurgy and pyrometallurgical processes. Disclosed herein are devices and systems for processing LBF slag into various steams including valuable metals and marketable fillers. The disclosed devices and systems may comprise for example: a furnace, a vessel, and a filter system. The furnace may aid in separating out As, Pb, S, Sb, and Sn from the LBF, for example via a fume. The furnace may be operated to produce low vaporization, or fuming, of sodium, such that all or the majority of sodium present in the LBF remains in the vessel. The sodium may be removed from the vessel as an iron-sodium-silicate slag (referred to herein as SCRUM slag). SCRUM slag is low in hazardous elements allowing it to be valorized into new products.

The disclosed filter system may comprise one or more filter cartridges and bag houses. The filter system may aid in capturing dust within the exhaust fume. In many embodiments, the dust from the exhaust fume may be rich in Pb and Sn. Pb and Sn from the dust may be processed in a furnace, for example an induction or rotary furnace, to form a Pb—Sn-rich bullion and furnace slag byproduct. The furnace slag byproduct from bullion production may be repurposed elsewhere as SCRUM slag.

The disclosed processes and systems may include further processing of the Pb—Sn-rich bullion. For example, Pb—Sn-rich bullion may be subjected to a refining process through the addition of chemicals, which may aid in separating out impurities from the bullion. In some embodiments, the refining process may produce a dross, which may be reused elsewhere, for example as a fluxing byproduct. In many embodiments, the refined Pb—Sn bullion may be subjected to an iterative vacuum distillation process, which may aid in concentrating the collected Sn to higher grade, for example commercial grade of 99.9% purity or greater. The lead, which can contain Sb for example, can be reused in the process for making Pb alloys for lead acid battery manufacturing. The recovered and, optionally refined, Pb and Sn may, in one embodiment, be incorporated into Pb alloys for lead acid battery manufacturing.

An intermediate leaching process is utilized for removal of trace elements (for example, without limitation Cd, Se, As, Fe, and Sb in the bag house dust as concentrations of, high vapor pressure element increases, for example Cd and Se. Bag house dust is removed from the regular process of briquetting to a side stream hydrometallurgical process to precipitate-out and decrease concentrations of one or more contaminants or hazardous elements, for example Cd and Se.

The disclosed methods, processes, and systems may be useful in eliminating or substantially reducing solid waste diverted to landfill disposal from lead-acid battery recycling. In some embodiments, the amount of material sent to landfill may be significantly reduced, for example by more than about 20%, 30%, 40%, 50%, 60%, 70%, 80%, 90%, 91%, 92%, 93%, 94%, 95%, 96%, 97%, 98%, or 99% by weight compared to the weight of the LBF slag processed with the disclosed processes and systems.

In one embodiment, a method for processing a silica-sodium-lead slag is disclosed. The method includes obtaining the silica-sodium-lead slag; placing the silica-sodium-lead slag into a furnace; heating the silica-sodium-lead slag to produce an offgas containing tin and lead, and a reduced metals sodium rich slag; collecting at least a portion of the offgas; and thereby reducing the tin and lead content of the silica-sodium-lead slag to produce the reduced metals sodium rich slag.

In another embodiment, a slag material is disclosed. The slag material includes sodium, at greater than about 5% and less than about 15% of the total weight of the slag material. The slag material includes lead, at greater than about 0.01% and less than about 0.1% of the total weight of the slag material. The slag material includes tin, at greater than about 0.01% and less than about 0.1% of the total weight of the slag material.

This Summary is provided to introduce a selection of concepts in a simplified form. It is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1 is an annotated flow chart of one embodiment of the disclosed processes and systems, which may be referred to as Slag Cleaning and Recovery of Useful Metals Plant or SCRUM (Process Overview).

FIG. 2 shows a simplified furnace flow diagram.

FIG. 3 shows a graph of furnace bath temperature versus time at various burner stoichiometry.

FIG. 4 is a graph showing slag Pb concentration at various stoichiometries for one embodiment of the disclosed processes and systems.

FIG. 5 is a graph showing slag Sn concentration various stoichiometries for one embodiment of the disclosed processes and systems.

FIG. 6 is a graph showing Pb slag concentration over time.

FIG. 7 is a graph showing Sn slag concentration over time.

FIG. 8 is a graph showing As slag concentration over time.

FIG. 9 is a graph showing Sb slag concentration over time.

FIG. 10 is a graph showing S slag concentration over time.

FIG. 11 shows Leach liqueur concentrations of metals removed from fume dust.

FIG. 12 shows Tin recovery results from DOE matrix testing.

FIG. 13 shows impurity removal of DOE matrix testing.

FIG. 14 shows the standardize effect of Leach parameters for AS-Fe—Sb Removal.

FIG. 15 shows the effect plots on impurity removal of DOE leach testing.

FIG. 16 is a flow chart of Vacuum Distillation Mass Distribution of Pb/Sn Flow.

FIG. 17 shows distribution of elements of interest in initial trials.

FIG. 18 shows proportions of slag in wt %.

FIG. 19 shows the VDU batch pilot results without pre or post-refining.

FIG. 20 shows a table of test results for the first vacuum distillation process pass.

### DETAILED DESCRIPTION

The disclosed compositions, devices, methods, processes, and systems are directed to recovering useful metals from lead acid battery recycling waste and/or LBF slag, removing undesirable materials, and producing compositions desirable for use in downstream product manufacturing, for example fillers. The disclosed methods, processes and systems are useful in preventing LBF slag from being landfilled.

### Lead Acid Battery Slag

Lead acid battery recycling produces a silica and sodium (Si—Na) slag rich in iron (Fe) as a solid waste. This slag waste product can be produced by many different furnace types, including, but not limited to, blast furnace, electric furnace, reverb furnace, short rotary furnace, top submerged lance furnace, SKS furnace, oxygen-bottom-blown-furnace, and oxygen-side-blown-furnace. This slag may be referred to herein as Lead Blast Furnace Slag, LBF slag, or LBFS. The application of this technology described here within would be equal to slag waste products from any other furnace type. In most embodiments, LBF slag is nonhazardous but comprises metals of value in small concentrations and elements that are undesirable for downstream uses, such as waste product filler and other products for use in commercial markets.

Prior to Applicant's presently disclosed methods, processes, and systems, the processing of LBF slag to recover valuable metals has been economically unfavorable. Moreover, LBF slag from secondary lead smelting has not been capable of valorization into other products as is possible with slag produced in other industries (i.e. steel blast furnace slag). Processes described herein, provide for economic recovery of valuable metals from LBF slag, removal of unwanted elements, and valorization into other useful commercial products. Moreover, the disclosed methods, processes, and systems significantly reduce the amount of LBF slag sent to landfills.

### Slag Processing to Recover Pb and Sn and Remove RCRA Metals

### Top Blown Rotary Furnace (TBRC)

LBF slag from processing of lead acid batteries is generally low in lead (Pb; 1-4 wt %), tin (Sn; 1-3 wt %), and antimony (Sb; <1 wt %). In some instances, LBF slag can have lead concentrations as high as 10% and tin concentrations as high as 10%. As such, the LBF slag can be referred to herein as silica-sodium-lead slag. Typically, LBF slag is tested for non-hazardousness by a leaching test. In the USA the test used to determine is solid waste material is hazardous is the Toxicity Characterization Leaching Protocol (TCLP test) as defined in the Resource Conservation and Recovery Act (RCRA). If the waste material is determined to be non-hazardous, it is sent to landfills. If the waste material is determined to be hazardous it is sent to hazardous landfills or alternatively it may be reprocessed, for example in a blast furnace where it may be reused as a flux. In some embodiments, the LBF slag may also be treated with one or more additives, for example an additive to keep elements from leaching, for one example pH adjustments, such as lime, or chelants, or it may be disposed of as a hazardous material. However, Applicants have surprisingly found that LBF slag can be efficiently and economically processed to recover the small concentrations of valuable metals, remove hazardous compounds, and produce an environmentally friendly and commercially useful product.

The first step in the disclosed methods and processing of LBF slag is pyroprocessing, or pyrometallurgy, of the LBF slag. In many embodiments, the LBF slag is transferred to a TBRC furnace for the processing. In many embodiments the LBF slag may be batch-fed into the TBRC furnace, which, in some embodiments, is a closed furnace. In most embodiments, the LBF slag is placed in a vessel of the furnace.

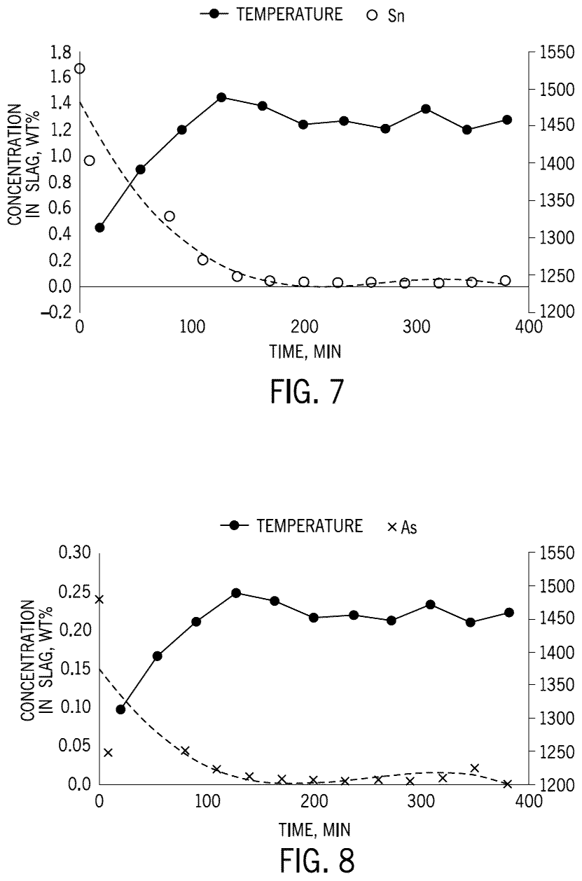

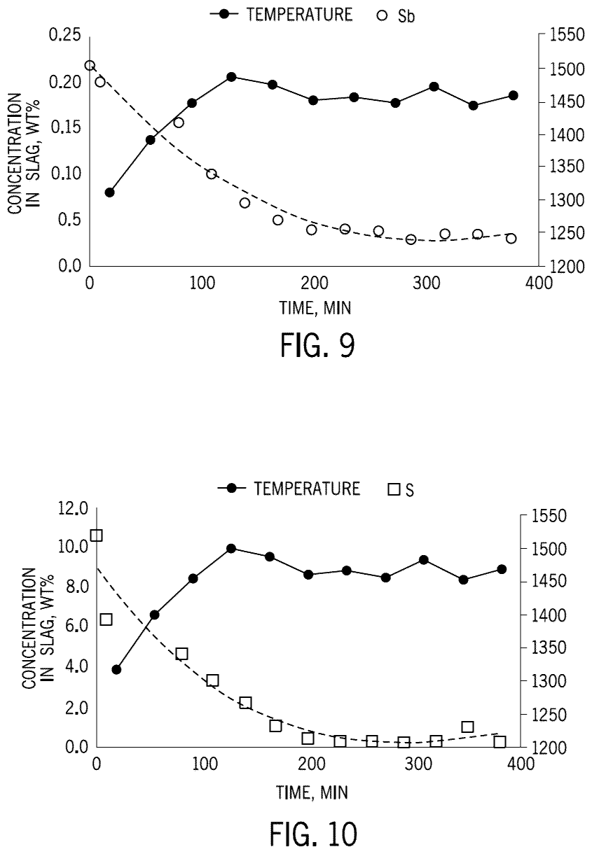

The disclosed methods and systems may involve operating the furnace at various conditions. In many embodiments, the operating temperature of the furnace may be between about 1200 and about 1600° C., for example about 1400 and about 1500° C. In many embodiments, the temperature may be maintained at about 1450° C. or between about 1420 and about 1470° C. In many embodiments, the furnace is fed with cold LBFS, and the operating temperature of the furnace may be achieved about 50-500 minutes after introduction of the LBFS into the vessel of the furnace. In some embodiments, the operating temperature is achieved in about 150-300 minutes, for example about 200 minutes. The cold LBFS can be in the form of granulated slag millimeters in diameter, or course slag chunks many centimeters in diameter. In some embodiments, the furnace can be fed with molten LBF slag and operating temperature achieved within 60 minutes. In various embodiments, the vessel of the furnace may include a lance or similar device to aid in heating the LBF slag. FIGS. 6-10 show the molten bath temp relationship vs time and elementals of interest in the slag.

The temperature of the disclosed LBF slag may be raised by a fuel/oxygen mixture of various stoichiometries. In various embodiments, stoichiometries may be from about 70% to about 90%, for example from about 73% to about 88%. In many embodiments, a fuel-lean or excess O₂ stoichiometry may be sued. In many embodiments, the stoichiometry may be referred to as fuel-rich. In many embodiments, the fuel richer stoichiometry may be favored for the disclosed methods and systems.

Combustion stoichiometries may be calculated in various ways. In one embodiment combustion stoichiometries may be calculated from an oxyfuel burner using the combustion equation (based on moles of reactants) shown below. The upper ratio represents the mols of fuel and O₂ actually consumed by the process, while the lower ratio represents the theoretical mols of fuel and O₂ necessary for complete combustion—with i.e. wherein total oxygen addition is greater than needed for full combustion.

$$Stoichiometric Combustion : {C}_{3} {H}_{8} + 5 {O}_{2} \to 3 C {O}_{2} + 4 {H}_{2} O \qquad ( eq 1 )$$

$$Stoichiometric Fuel Ratio : ∅ = ( ( Actual Fuel Moles ) / ( Actual {O}_{2} Moles ) / ( Stoichiometric Fuel Moles ) / ( Stoichiometric {O}_{2} Moles ) ) \qquad ( eq 2 )$$

In some embodiments, the vessel of the furnace wherein the LBF slag is heated, may be rotated, or otherwise agitated during the process. In some embodiments, the vessel may be rotated at a speed of about 5-50 rpm, for example about 10-30 rpm. In some embodiments, the vessel is rotated at about 20 rpm. In many embodiments, the rotation and/or agitation may depend upon the size and shape of the vessel and/or the material load. Various processing times may be employed. In most embodiments, the processing time may be less than about 500 minutes. Agitation may also be introduced in the form of gas sparing from a lance, for example using a Top Submerged Lance (TSL) furnace, or from tuyeres, for example using an oxygen side blown furnace.

Stoichiometry and fluxes play a role in the overall processing time as well as the resulting TBRC slag chemistry.

Furnace processing separates specific metals within the LBF slag, generally, into two streams—an exhaust fume stream and a SCRUM slag stream. The pyroprocessing/TBRC step may be optimized to achieve specific SCRUM slag compositions, recovery of useful metals and compounds in the fume (for example sodium, iron, silica, tin, antimony, etc.) and for removal of RCRA metals (such as arsenic, barium, cadmium, chromium, lead, mercury, selenium, and silver). Applicants have surprisingly found that useful metals may be separated by unique fuming processes that minimize or eliminate Na in the fume exhaust. For example, Applicants have identified pyroprocessing parameters that unexpectedly maintains sodium in the SCRUM slag within the vessel, rather than partitioning to the exhaust fume stream. Applicant's methods, processes, and systems are in contrast to existing processes, which transfer significant amounts, or substantially all, of the sodium in the LBF into the exhaust fume. In the present process, the exhaust fume from the TBRC vessel is directed out of the furnace and captured in a dust collection system. In most embodiments, the dust collection system may comprise one or more cartridge filters and bag houses. The furnace processing removes all or substantially all the As, Pb, S, Sb, and Sn from the LBF slag and directs them into the exhaust fume, while leaving an iron-rich liquid sodium-silicate SCRUM slag in the vessel of the TRBC furnace, also referred to herein as a reduced metals sodium rich slag. Reduced metals can or may include one or more of Sn, Sb, and metals subject to the Resource Conservation and Recovery Act (RCRA), such as Pb and As. This SCRUM slag is then solidified and processed for use in various commercial products, for example reuse of reprocessed slag can replace other more costly ingredients used to make building and roadway materials. The exhaust fume stream captured during the TBRC step generally comprises elevated concentrations of Pb and Sn and minimal concentrations of other elements (e.g. sodium). The exhaust fume stream is also referred to herein as an offgas. The offgas can or may include particles, such as Pb and Sn particles.

Table 3 in Example 1 shows the concentration of LBF slag from lead acid battery recycling that is typically landfilled. This LBF slag is reduced, after being subjected to Applicant's processes and system, by 5-35% of total weight. By maintaining the sodium in the SCRUM slag, the SCRUM slag can be repurposed into various products, for example as additives to cements and concretes.

As the process continues:

The fume and baghouse dust are removed from the dust collection to be processed further to recover the concentrated metals of value.

The fume compositions are described in Example 1, Table 4. Recovery of Pb >98% and recovery of Sn is >99%.

The TBRC furnace maintains the sodium-silicate-iron rich slag which is granulized or casted into molds to produce a desired product for manufacturers using it as waste filler in product manufacturing. At this stage it needs no further processing because nearly all toxic elements are removed and resulting slag passes leaching tests.

Process parameters play a key role in the economics due to the nature of upstream processes, i.e., due to the low concentrations of Pb and Sn in the LBF Slag available for recovery, in order to maximize the recovery of valuable metals. With low volumes of Sn and Pb recovery processing time is a primary factor. After the dust is collected in cartridge filters, the exhaust fume travels to bag houses of a pollution control system.

The dust collected in the bag house, because it contains Pb and Sn, is also processed back to the briquetter for further processing.

The SCRUM slag is commercially desirable. In some embodiments, the SCRUM slag is usable as a substitute in various products such as structural refractories like pavers and concrete blocks, 3D mortar printing, and roadway aggregates. Prior to Applicant's disclosed methods and systems, LBF slag was not able to be resold and/or used as waste filler material due to the presence of undesirable elements and compounds. Typically, LBF was required to be landfilled as hazardous or nonhazardous solid waste, or, in some cases, used at large secondary smelters as tailings. Other beneficial opportunities for SCRUM slag may include roadway substitute in asphalt or concrete roads and aggregates.

### Furnace

Dust collected in the filter system may be collected for further processing. For example, this dust may be amalgamated into briquettes. Further processing of the dust may include transferring the dust to a furnace. The furnace may aid in producing a Pb—Sn rich bullion. In many cases, in addition to production of a Pb—Sn-rich bullion, minor elements or impurities (for example, without limitation Cu, Fe, Na, S, Se, Si) may be partitioned to a furnace slag. By-product drosses may be blended with the dusts. This can be drosses containing high concentrations of lead, in addition to high concentrations of tin and sodium for detinning drosses, or decoppering drosses containing high concentrations of iron and sulfur.

The presently disclosed TBRC operating parameters result in the portioning of sodium between the SCRUM slag and exhaust fumes. This results in the majority of sodium remaining in the slag and fuming off sufficient amounts of sodium being in the fume flow to function as a required flux in the reduction to bullion process and no additional Na needs to be added. Silica and anthracite may be added to the furnace to act as a flux, which may also generate desirable slag conditions. Tin levels in the bullion are typically about 30-40% wt, lead concentration is typically 50-60% wt, and 3-4 wt % Sb. The slag produced in the furnace is a clean SCRUM slag. This flux may aid in avoiding a solid waste stream since it has a low volume and contains Fe, Na and Si.

The furnace processing of the collected dust may produce an off-gas. The off-gas from the furnace may be directed to and collected by a pollution control system.

### Refining Kettle

The Pb—Sn rich bullion may be collected for further processing. In many embodiments, this bullion may be refined, for example in an open vessel. This refining may aid in removing impurities in the bullion such that the refined bullion may be processed in a vacuum distillation process. The refining process produces a dross, which contains small amounts of Pb, Sn, and fluxing agents. The fluxing agents may be reprocessed in a blast furnace or the TBRC to aid in recovering Pb, Sn and to help avoid a solid waste stream.

Off gas stream from the rotary furnace again routes through a pollution control system for purification before being emitted to ambient. Minor concentrations of usable metals in the dust (<0.1% from the rotary furnace) are accumulated with the higher concentration TBRC furnace dust for recovery.

### Vacuum Distillation for Commercial Sn Grade Product

The Pb—Sn metal from the refining process is then brought through vacuum distillation. The process is iterative to condensate Sn and recirculate a Pb—Sn distillate. Each stage produces a Sn condensate and Pb—Sn distillate, condensate concentration is iterated until a 98.5 wt % Sn condensate is reached. Trace elements such as copper, iron, and nickel are removed to reach a 99.9% Tin bullion. The byproduct is a crude lead alloy which is refined in the plants current process.

The 98.5 wt % Sn condensate is melted in a refining kettle for copper and nickel removal leaving a 99.9% Sn bullion that is casted into a final product. The product is used in the current lead acid battery recycling final process step of making alloys for new battery production. The recovery of Sn in the overall plant flowsheet is greater than the quantity needed to make battery lead alloys and the surplus is sold to other industries or customers in the battery recycling industry. The Pb byproduct (80% wt Pb) of vacuum distillation is used in the current lead acid battery recycling final process step of making alloys for new battery production. Off gas of VDU is routed through a pollution control system for purification before being emitted to ambient.

### EXAMPLES

### Example 1 TBRC Test Fuming of Sn and Pb while Controlling the Na Partition—Setup and Results

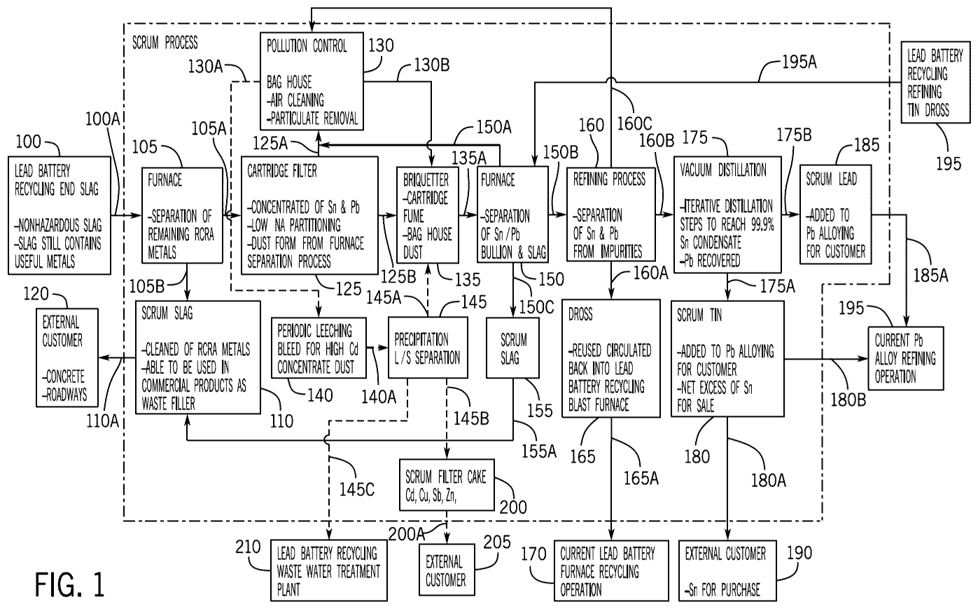

A TBRC furnace with oxyfuel burner (lance) was used to heat a rotatable vessel. FIG. 1 is a simplified flow diagram of the presently disclosed process facility. For example, the SCRUM process may include some or all of the steps or operations enclosed by the dash-dot-dash line or otherwise disposed within the dash-dot-dash line boundary in FIG. 1. In other examples, the SCRUM process may include some or all steps or operations depicted in FIG. 1. For example, with reference to the arrow lead lines depicted in FIG. 1, the arrow lead lines may indicate continuous or non-continuous processes. In some cases, dashed arrow lead lines may indicate a more intermittent process than solid arrow lead lines. For example, dashed arrow lead lines may indicate that a triggering event may occur prior to the operation that the dashed arrow lead line points to. The process may begin with operation 100 and slag from recycled lead-acid batteries may be received, e.g., by a recycled battery processing facility. For example, battery recycling processes may result in a slag byproduct. The slag may include or contain metals, which may inhibit the industrialization or beneficial use of the slag due to the leachability of certain metals included in the slag. The metals included in the slag may be useful metals, such as sodium, iron, silica, tin, antimony, and the like. For example, the useful metals included in the slag may also be or include RCRA metals, such as arsenic, barium, cadmium, chromium, lead, mercury, selenium, and silver.

As depicted by arrow 100A, the process may proceed to operation 105 and the slag may be sent to a furnace, such as a first furnace, where at least a portion of the metals included in the slag, such as the RCRA metals, can be separated from the slag. As depicted by arrow 105B, the processed slag may proceed to operation 110. For example, the processed slag may be substantially cleaned of or otherwise separated from the RCRA metals. Additionally, the furnace at the operation 105 may be operated to produce low vaporization, or fuming, of sodium, such that all or the majority of sodium present in the slag remains in the vessel. The sodium may be removed from the vessel as an iron-sodium-silicate slag (referred to herein as SCRUM slag). Thus, the processed slag may be referred to as SCRUM slag, which may be low in hazardous elements allowing it to be used in new products, such as commercial products as waste filler. For example as depicted by arrow 110A, the SCRUM slag can proceed to operation 120. At the operation 120, the SCRUM slag can be sent to an external customer for use in concrete, roadways, and the like, for example.

As depicted by arrow 105A, the separated RCRA materials may proceed to operation 125. For example, the processed slag at operation 110 may be substantially cleaned of or otherwise separated from the RCRA metals, for example via a fume, e.g., a mixture of particles and dust in the off gas stream. At the operation 125, the fume may proceed through at least one cartridge filter. The cartridge filter, which may be part of a filter system, may capture dust within the fume, which may be rich in lead, tin, and the like. In other words, the dust may include a high concentration of tin, lead, and the like and a low sodium partitioning.

The process may include additional filters or pollution control means. For example as depicted by arrow 125A, at least a portion of the dust may proceed to operation 130. At operation 130, the dust may pass through a bag house or other fabric filter, which may be part of the filter system, where the air is cleaned and particulates are removed. In this way, the dust may be referred to as bag house dust. As depicted by arrow 130B, the bag house dust may proceed to operation 135 where the bag house dust may be processed by a briquetter. As depicted by arrow 130A, the dust or bag house dust may proceed to operation 140 where periodic leaching bleed for high cadmium and/or selenium concentrate dust is obtained. For example, operation 140 may occur subsequent to an occurrence of a triggering event, such as concentrations of cadmium and/or selenium meeting or exceeding a threshold value in the fume.

As depicted by arrow 140A, the dust may proceed to operation 145 where precipitation and liquid-solid separation of the dust occurs. As depicted by arrow 145A, a portion of the product, originally referred to as the bag house dust, from the operation 145 may proceed to the operation 135 where the portion of the product is processed by the briquetter. As depicted by arrow 145B, a portion of the product, originally referred to as the bag house dust, from the operation 145 may proceed to operation 200 where a scrum filter cake including cadmium, copper, antimony, zinc, and the like is formed. As depicted by arrow 200A, the scrum filter cake may proceed to operation 205 and be sent to an external customer. As depicted by arrow 145C, a portion of the product, originally referred to as the bag house dust, from the operation 145 may proceed to operation 210 where the portion of the product is sent to a lead battery recycling waste water treatment plant.

Referring back to the operation 125, the fume passed through the cartridge filter, which may be referred to as the cartridge fume, may proceed to the operation 135, as depicted by arrow 125B, and be processed by the briquetter. As depicted by arrow 135A, the tin and lead from the dust and/or fume, e.g., the dust and fume in a compacted form such as pellets, may proceed to operation 150 and be processed in or by a furnace, such as a second furnace, for example an induction or rotary furnace, to form a tin and lead bullion and a slag, such as a furnace slag byproduct. As depicted by arrow 195A, the process may include operation 195, wherein outside product streams are introduced to the process. Here lead battery recycling and refining of tin dross from outside processes may be added to the operation 150. As depicted by arrow 150A, at least a portion of the product, such as a fume and/or dust, processed by the second furnace may proceed to the operation 130 and any subsequent operations described above with respect to the operation 130. As depicted by arrow 150C, the furnace slag byproduct, e.g., a solid slag, from bullion production may proceed to operation 155 and be repurposed elsewhere as SCRUM slag. For example, the repurposed SCRUM slag may proceed to the operation 110, as depicted by arrow 155A, and any subsequent operations described above with respect to the operation 110.

As depicted by arrow 150B, the tin and lead bullion, e.g., a solid tin and lead concentrated bullion, formed at operation 150 may proceed to operation 160 and pass through a refining process where the tin and lead are separated from impurities. For example, the refining process may include adding chemicals that aid in separating out impurities from the bullion. As depicted by arrow 160C, a portion of the product, such as a fume and/or particle and/or dust, passed through the refining process may proceed to the operation 130 and any subsequent operations described above with respect to the operation 130. As depicted by arrow 160A, the refining process may produce a dross, which may proceed to operation 165 and be reused elsewhere, for example as a fluxing byproduct. For example, the dross may be recirculated into the lead battery recycling blast furnace and, as depicted by arrow 165A, the dross may proceed to operation 170 and be sent through a lead battery furnace recycling operation.

As depicted by arrow 160B, the refined tin and lead bullion may proceed to operation 175 and pass through vacuum distillation, which may include iterative distillation steps to reach about 99.9% tin condensate as well as recover lead. For example, the vacuum distillation process may aid in concentrating the collected tin to higher grade, for example commercial grade of 99.9% purity or greater. As depicted by arrow 175A, the tin, which can be referred to as SCRUM tin, can proceed to operation 180. The SCRUM tin can be added to lead alloying, e.g., for customers, and the net excess of the tin can be sold. For example, the excess tin may be purchased by a customer at operation 190, as depicted by arrow 180A. As depicted by arrow 175B, the lead, which can be referred to as SCRUM lead, can proceed to operation 185. The SCRUM lead can be added to lead alloying, e.g., for customers. For example, the SCRUM lead, which can contain antimony for example, may be reused in the process for making lead alloys for lead acid battery manufacturing. In other words, both of the recovered and refined lead and tin may be incorporated into lead alloys for lead acid battery manufacturing. As depicted by arrow 185A, the lead incorporated into lead alloys, and as depicted by arrow 180B, the tin incorporated into lead alloys may each proceed to operation 195 and pass through a lead alloy refining operation.

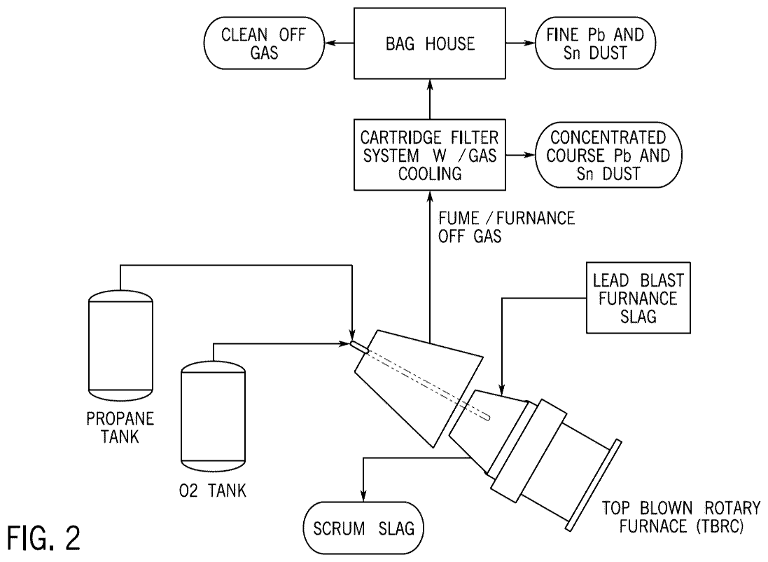

Propane gas was selected as fuel supply to the oxyfuel burner at stoichiometries of 73%-88%. The TBRC vessel was rotated at varying speeds (10-20 RPM) with desired agitation at max allowed 20 RPM. Attached to the vessel were extraction hoods that lead the airstream to a cartage filter bank, after cooling the stream in a trombone, to collect fume dust with high concentrations of Pb and Sb leaving the Na in the slag. From the cartridge filters, the off-gas stream went to a bag house to collect remaining particulate in the gas stream. This is also collected to recover Pb and Sn. Setup of the TBRC operation is shown in FIG. 2.

The vessel was heated up and then batch fed with 10 kg of slag until it melted and then 10 kg of slag was added until 50 kg in total additions were made. Kinetic samples were taken for analysis of the slag composition over time. Sn recovery dictated the total processing time to clean the slag, 200 min (from the time the first 10 kg addition becomes liquid) was needed to remove desired metals from the slag to create a clean commercial use waste filler.

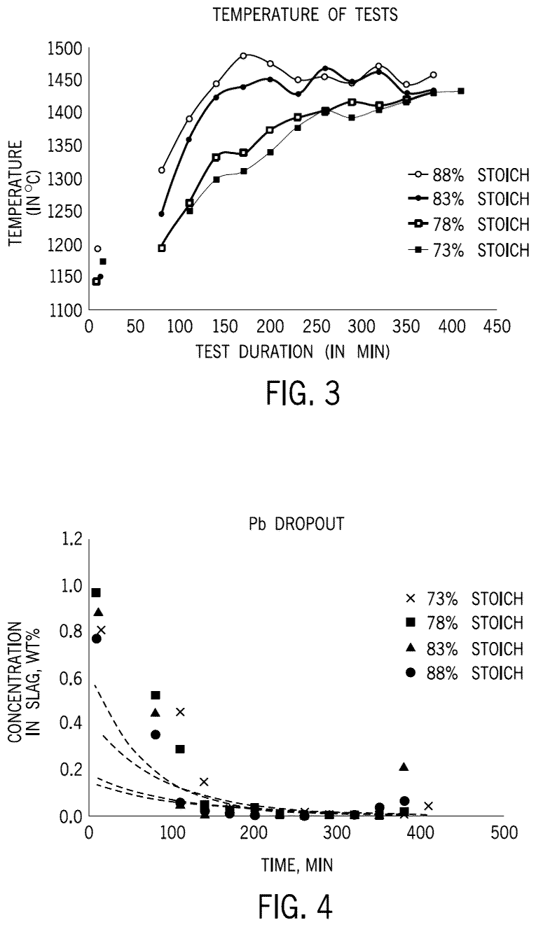

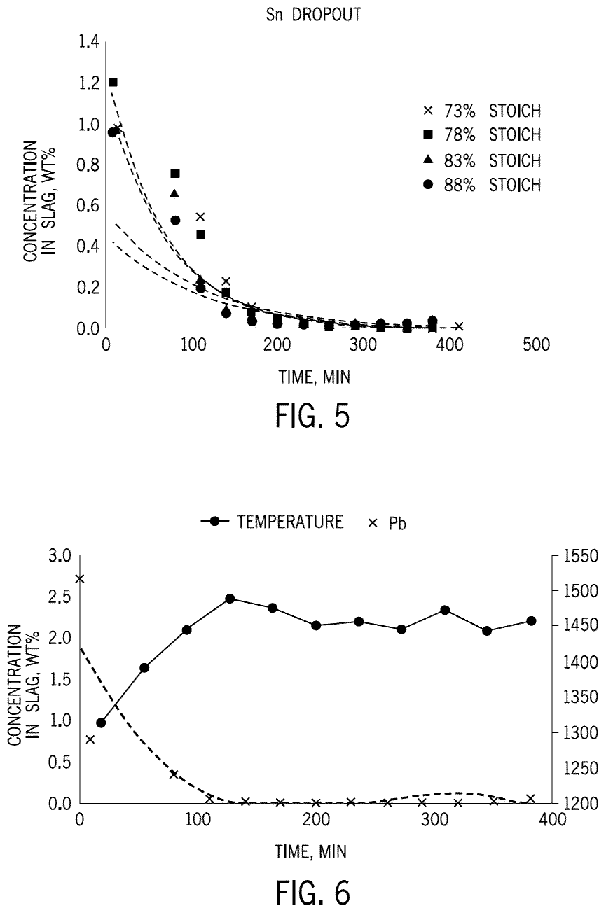

Gas stoichiometries were plotted as Temp vs. Duration in FIG. 3. Results from these ratios and molten TBRC bath temperature relationships showed at a higher gas stoichiometry the bath was able to reach higher temperatures faster. FIG. 4 and FIG. 5 plots the relationship between gas stoichiometry and SCRUM slag concentrations of Pb and Sn respectively in the TBRC vs. Duration.

Reaching temperatures faster resulted in fuming off desired metals at a higher rate in the first 2 hrs. However, to fully remove the lead and tin the times remained the same. In addition, Sb leveled off at 0.04 wt % after 200 min and wasn't fully removed at the higher stoics (83% & 88%) where it was at the lower stoics (73% & 78%).

Pb and Sn were less than 0.05 wt % and 0.03 wt % in the remaining slag respectively. Partitioning coefficients between the slag and fume are listed below.

TABLE 1
TBRC Partitioning Coefficients

| | Pb | Sn | S | Sb | Na | Fe | Si |
|---|---|---|---|---|---|---|---|
| P, C_{Fume}/C_{SCRUM Slag} | 3465.46 | 527.91 | 7.87 | 675.42 | 0.37 | 1.77E−03 | 0.03 |
| P, C_{SCRUM Slag}/C_{Fume} | 2.89E−04 | 1.89E−03 | 1.27E−01 | 1.48E−03 | 2.68 | 565.00 | 34.57 |

TABLE 2
TBRC Fume and Slag Element Weight Percents

| | Pb | Sn | Na |
|---|---|---|---|
| LBF Slag wt % | 4.2 | 1.2 | 14.2 |
| Fume wt % | 42.4 | 10.4 | 5.4 |
| SCRUM Slag wt % | 0.03 | 0.025 | 10.1 |

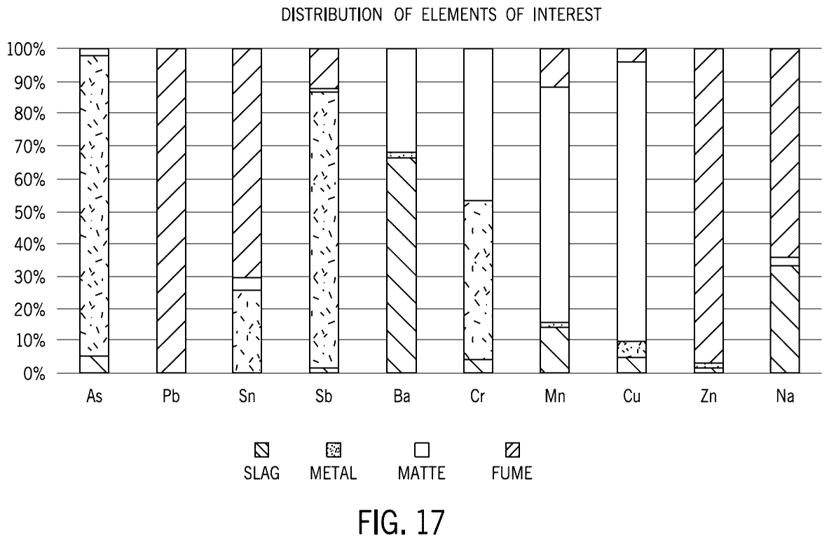

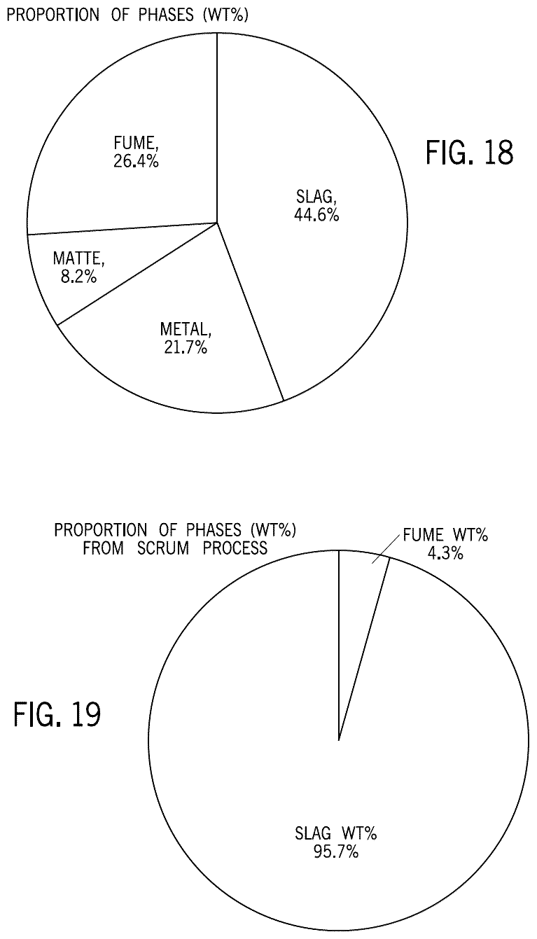

Surprisingly, this presently disclosed SCRUM process maintains the iron rich sodium-silicate slag because it prevents the release of sodium into the fume which has not been accomplished prior. Applicants discovered that the sodium partitioning could be significantly changed from what is traditionally possible, resulting in enhanced recovery characteristics. For example, by controlling the sodium partition to the slag and fume, the presently disclosed SCRUM process allows only the concentration of sodium needed to flux the reduction of the fume to a Pb—Sn bullion to reach the fume. Initial testing indicated that these results were not achievable. Specifically, original tests showed that the majority of sodium reported to the fume: approximately 65 wt % of the incoming sodium reporting to the fume and 35% to the slag. The total tin reporting to the fume was also lower at roughly 70 wt % of the total tin with 30 wt % reporting to the slag and metal. FIG. 17 displays the partitioning relationships of elements in the fuming process. Initial results were also undesirable due to the presence of metal and matte phases—significantly complicating downstream processing and recovery. In some embodiments, the matte and metal phases may result from a reducing environment. In some embodiments, a matte phase may result from high concentrations of sulfur in the slag. In some embodiments this will lead to a mixture sulfides formed as an intermediate product of smelting. In some embodiments, a metal phase may result from reduction of one or more elements from their oxide phase preventing the element from fuming. FIG. 18 shows the original distributions of wt % among the four phases: fume, slag, matte, and metal.

Applicants have surprising found that the presently disclosed SCRUM fuming process was able to significantly enhance reporting of valuable metals to fume while simultaneously decreasing sodium. Moreover, the presently disclosed SCRUM process results in two phases, rather than four. These results were unexpected. The resulting fume and slag wt percent values from the present SCRUM process are shown in FIG. 19. While the total fume wt % in FIG. 19 is decreased relative to that shown in FIG. 18, selectivity of proportioning, especially for desired metals, to fume increased. This beneficial result provides for concentrating desired recovery of metals into the fume stream, simplifying processing the fume in subsequential steps of the SCRUM Process.

The disclosed SCRUM process may result in a reduction of the number and complexity of phases resulting from initial steps. In many embodiments, the resulting phases may be a slag phase and a fume or offgas phase. In these embodiments, the percent weight of a resulting fume phase from the presently disclosed SCRUM process may be from about 2% to about 6%, for example greater than or equal to about 1.5%, 2%, 2.5%, 3%, 3.5%, 4%, 4.3%, 4.5%, 5%, 5.5%, 6%, or 6.5%, and less than or equal to about 7%, 6.5%, 6%, 5.5%, 5%, 4.5%, 4.3%, 4%, 3.5%, 3%, 2.5%, 2%, 1.5%, or 1%. In some embodiments, the percent weight of resulting slag phase from the SCRUM process may be from about 92.5% to about 99.5%, for example greater than or equal to about 91.5%, 92%, 92.5%, 93%, 93.5%, 94%, 94.5%, 95%, 95.5%, 95.7%, 96%, 96.5%%, 97%, 97.5%, 98%, 98.5%, or 99% and less than or equal to about 99.5%, 99%, 98.5%, 98%, 97.5%, 97%, 96.5%, 96%, 95.7%, 95.5%, 95%, 94.5%, 94%, 93.5%, 93%, 92.5%, 92%, 91.5%, or 91%.

The resulting phases, e.g., the slag phase and the fume or offgas phase, of the disclosed SCRUM process may each comprise Na, as depicted in Table 2. In these embodiments, the total weight of the sodium in the offgas phase may be from about 1% to about 10% of the total weight of the offgas, for example greater than or equal to about 1%, 2%, 3%, 4%, 5%, 5.4%, 6%, 7%, 8%, 9% or 10%, and less than or equal to about 10%, 9%, 8%, 7%, 6%, 5.4%, 5%, 4%, 3%, 2%, or 1%. Further, the total weight of the Na in the slag phase may be from about 5% to about 15% of the total weight of the slag, for example greater than or equal to about 5%, 6%, 7%, 8%, 9%, 10%, 10.1%, 11%, 12%, 13%, 14%, or 15% and less than or equal to about 15%, 14%, 13%, 12%, 11%, 10.1%, 10%, 9%, 8%, 7%, 6%, or 5%.

The resulting phases, e.g., the slag phase and the fume or offgas phase, of the disclosed SCRUM process may each comprise Pb, as depicted in Table 2. In these embodiments, the total weight of the Pb in the offgas phase may be from about 35% to about 50% of the total weight of the offgas, for example greater than or equal to about 35%, 40%, 42.4%, 45%, or 50%, and less than or equal to about 50%, 45%, 42.4%, 40%, or 35%. Further, the total weight of the Pb in the slag phase may be from about 0.01% to about 0.1% of the total weight of the slag, for example greater than or equal to about 0.01%, 0.02%, 0.03%, 0.04%, 0.05%, 0.06%, 0.07%, 0.08%, 0.09%, or 0.1% and less than or equal to about 0.1%, 0.09%, 0.08%, 0.07%, 0.06%, 0.05%, 0.04%, 0.03%, 0.02%, or 0.01%.

The resulting phases, e.g., the slag phase and the fume or offgas phase, of the disclosed SCRUM process may each comprise Sn, as depicted in Table 2. In these embodiments, the total weight of the Sn in the offgas phase may be from about 5% to about 15% of the total weight of the offgas, for example greater than or equal to about 5%, 6%, 7%, 8%, 9%, 10%, 10.4%, 11%, 12%, 13%, 14%, or 15% and less than or equal to about 15%, 14%, 13%, 12%, 11%, 10.4%, 10%, 9%, 8%, 7%, 6%, or 5%. Further, the total weight of the Sn in the slag phase may be from about 0.01% to about 0.1% of the total weight of the slag, for example greater than or equal to about 0.01%, 0.02%, 0.025%, 0.03%, 0.04%, 0.05%, 0.06%, 0.07%, 0.08%, 0.09%, or 0.1% and less than or equal to about 0.1%, 0.09%, 0.08%, 0.07%, 0.06%, 0.05%, 0.04%, 0.03%, 0.025%, 0.02%, or 0.01%.

Leach tests (EPA Toxicity Characteristic Leaching Procedure) showed environmental compliance. Test results below.

TABLE 3
TCLP Results of Initial and Cleaned Slags

| | Ag | As | Ba | Cd | Cr | Hg | Pb | Se |
|---|---|---|---|---|---|---|---|---|
| Description | ppm | ppm | ppm | ppm | ppm | ppm | ppm | ppm |
| LBFS | 0.01 | 0.03 | 81.8 | 0.05 | <0.01 | <0.01 | 66.85 | 0.54 |
| SCRUM Slag | <0.1 | <0.1 | 29.6 | <0.1 | <0.1 | <0.1 | <0.1 | <0.1 |
| TCLP limits | 5.0 | 5.0 | 100.0 | 1.0 | 1.0 | 0.2 | 5.0 | 1.0 |

Slag was also analyzed with QEMSCAN and XRD to get phase distributions. The feed furnace slag and the collected dust formed from volatilized fume were analyzed using ICP-OES, XRD-EDS, and QEMSCAN. The objective was to understand the volatilization behavior of furnace slag and the compositional and phase differences between the remaining slag and valorized product. ICP analysis indicates that almost all elements in the slag decreased over time except for silicon and aluminum. Most of the elements volatilized in about 2 hours under process conditions used. About 99% of the tin, 98% of Pb and 93% of Sb were volatilized from the slag. Below is the incoming slag and the cleaned slag mineralogy.

The fume dust stream was also analyzed by ICP and QEMSCAN/XRF to get elemental data and phase distributions. The mineralogy of the fumes is shown below.

TABLE 5
Modal mineralogy and elemental
mass of TBRC Fume

| | Mass % | | |
|---|---|---|---|
| | 3951-47 | | 3951-47 |
| Quartz | — | O | 9.72 |
| Chromite | — | Na | 0.01 |
| Si—Pb—Ca—Cr—Fe | 0.01 | Mg | tr |
| Na, Fe silicate | 0.04 | Al | tr |
| Na silicate, low fe | 0.02 | Si | 0.02 |
| Na—Al silicate, low Fe | — | S | 7.48 |
| Na—Ca—Al silicate, | 0.01 | Ca | tr |
| high Fe | | | |
| Imandrite (Na, Ca silicate) | 0.01 | Cr | tr |
| Ca—Fe sillicate | — | Fe | 1.60 |
| Ca—Al sillicate, low fe | 0.01 | Sr | 0.18 |
| Pb sillicates | 0.24 | Sn | 12.84 |
| Galena (Pb sulfide) | 3.55 | Sb | 22.49 |
| Pb—(S)—Sn oxide | 50.88 | Ba | tr |
| Pb—Sn sulfide | 42.17 | Pb | 44.61 |
| Fe Oxide | 2.25 | Unspecified | 0.78 |
| Pyrrhotite | 0.01 | Total | 99.76 |
| Chalcopyrite | — | | |
| other minerals | 0.02 | | |
| Unclassified | 0.78 | | |

tr <0.005%

### Example 2—Leaching Concentrated Metals from Recirculating Baghouse Dust with Sulfuric Acid

Baghouse dust will be a recirculating load with concentrations of Antimony, Arsenic, Cadmium, Iron, and Selenium increasing over time. To remove these impurities, a sulfuric acid leaching process is used. This method allows for removal of soluble metals leaving lead and tin behind for recovery.

### Leach Feed Material:

The material used in this leaching study is the fume product produced by the TBRC. The fume product was produced in 2 different tests then combined for the purposes of this testing. The elemental composition of the material was tested using ICP.

TABLE 6
ICP Results of Leach Feed Material

| Al wt % | As wt % | Cu wt % | Fe wt % | Na wt % | Ni wt % | Pb wt % | S wt % | Sb wt % | Se wt % | Si wt % | Sn wt % | Zn wt % |
|---|---|---|---|---|---|---|---|---|---|---|---|---|
| 0.0814 | 0.6557 | 0.1333 | 2.7637 | 1.9454 | 0.0127 | 44.856 | 6.6911 | 1.1562 | 0.0461 | 0.4314 | 13.302 | 1.6088 |

TABLE 7
QEMSCAN Speciation of Leach Feed Material

| | Mass % | |
|---|---|---|
| | 3951-47 | 3951-54 |
| Quartz | 0 | 0.01 |
| Chromite | 0 | 0.01 |
| Si—Pb—Ca—Cr—Fe | 0.01 | 0 |
| Na,Fe silicate | 0.04 | 0.02 |
| Na silicate, low Fe | 0.02 | 0 |
| Na—Al silicate, low Fe | 0 | 0 |
| Na—Ca—Al silicate, high Fe | 0.01 | 0.01 |
| Imandrite (Na, Ca silicate) | 0.01 | 0 |
| Ca—Fe silicate | 0 | 0 |
| Ca—Al silicate, low Fe | 0.01 | 0 |
| Pb silicates | 0.24 | 0.14 |
| Galena (Pb sulfide) | 3.55 | 1.75 |
| Pb—(S)—Sn oxide | 50.88 | 67.17 |
| Pb—Sn sulfide | 42.17 | 29.78 |
| Fe Oxide | 2.25 | 0.35 |
| Pyrrhotite | 0.01 | 0 |
| Chalcopyrite | 0 | 0 |
| other minerals | 0.02 | 0.01 |
| [Unclassified] | 0.78 | 0.74 |

Along with the ICP analysis this QEMSCAN shows that most of the material is tin lead oxide and sulfide.

### Scoping Test:

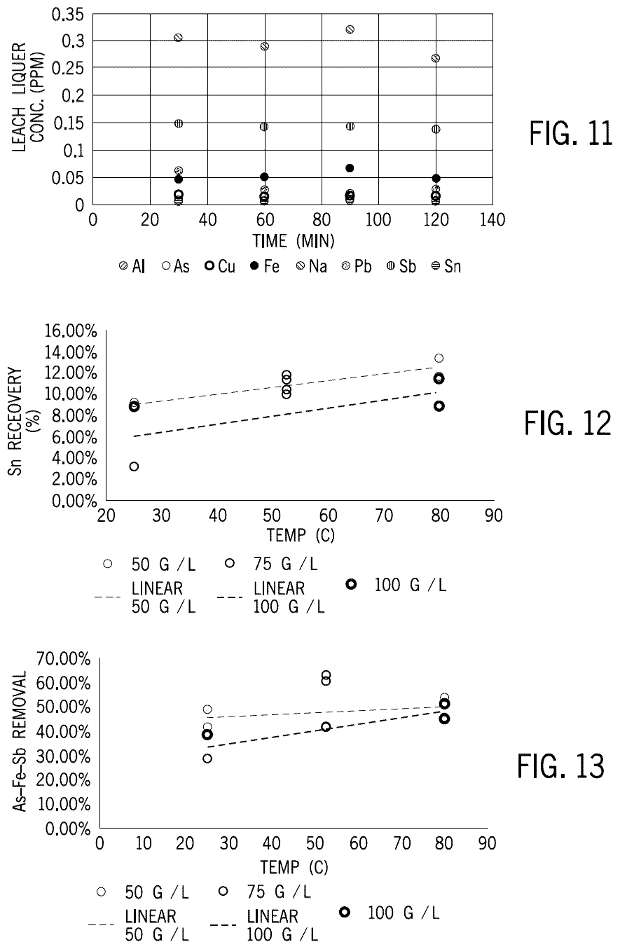

A scope leach test was conducted prior to running a DOE on impurity removal. After drying the residue was weighed and the appropriate dissolutions were performed to prep the leach solution for ICP-OES. The samples were then run on the ICP, and the concentrations calculated from the results. The results show a range of tin recovery from 3% to 13% over the changing parameters and an impurity removal rate from 28% to 62%. These results show that the elemental concentrations of the leach stayed relatively stable over all the testing times. The concentrations were also very similar between the mid test samples and the end bulk sample indicating that the sampling procedure was appropriate for the analysis procedure. What we see from the results in FIG. 11 is the concentrations of Al, As, Cu, Fe, Na, Sb, and Sn were all about the same showing that the dissolution of this material into the leach happened within the first 30 minutes of the leach. The calculated concentration of Pb decreased as the leach went on. Using the concentrations shown above the recovery of the leach was calculated over the time of the leach. The recovery of the tin being 0.5% was essentially level as the time of the leach went on indicating that the reaction occurring is relatively fast with these leach parameters

A DOE testing matrix was developed after the scope leach tests and performed examining the temperature, acid concentration, and slurry density against the removal of impurities and tin recovery of the leach. Cd was removed at greater than 85% across all tests. Selenium removal was dependent of the form (selenate or selenite). With those cases the focal point of the leach was on removal of As, Fe, and Sb. The results show that only temperature of the leach and the slurry density had significant impacts on the dissolution of the materials. With recovery increasing with temperature and decreasing with slurry density. The optimized leach conditions were calculated to maximize impurity removal at 45% removal and minimize tin dissolution at 8% dissolution. This optimized leach was shown to be at room temperature (25C), low slurry density (50 g/L), and low acid concentration (15 g/L). The leaching occurred rather quickly and showed that the process was not time dependent on removing acceptable amounts of impurities.

TABLE 8
DOE Matrix of Sulfuric Acid Leach Testing

| Run ID | Acid Concentration g/L | Temperature (C.) | Slurry Density g/l |
|---|---|---|---|
| 1 | 15 | 25 | 100 |
| 2 | 22.5 | 52.5 | 75 |
| 3 | 30 | 25 | 50 |
| 4 | 22.5 | 52.5 | 75 |
| 5 | 30 | 80 | 100 |
| 6 | 15 | 80 | 50 |
| 7 | 15 | 25 | 50 |
| 8 | 30 | 25 | 100 |
| 9 | 22.5 | 52.5 | 75 |
| 10 | 22.5 | 52.5 | 75 |
| 11 | 15 | 80 | 100 |
| 12 | 30 | 80 | 50 |

Removal of Cd and Se by weight were disregarded in the optimization due to high volume of Cd removal and Se removal dependent on phase which is not controlled in the process stream. Below are the recovery results in the leachate solution. This analysis allows for more elements to be analyzed by sacrificing some accuracy as increasing the number of wavelengths measured by the tool increases the chances of overlapping emission values. Which is an additional benefit to disregard the elements.

TABLE 9
Recovery of Elements in Leach

| | Cd | Se | | |
|---|---|---|---|---|
| | wt % | wt % | Sn wt % | As—Sb—Fe Removal |
| 1 Recovery | 68.4% | 27.0% | 2.8% | 31.7% |
| 2 Recovery | 113.3% | 7.2% | 11.1% | 75.3% |
| 3 Recovery | 93.3% | 10.2% | 7.9% | 54.6% |
| 4 Recovery | 119.1% | 6.9% | 10.9% | 77.9% |
| 5 Recovery | 86.1% | 1.9% | 8.6% | 58.6% |
| 6 Recovery | 116.4% | 5.1% | 10.9% | 79.7% |
| 7 Recovery | 104.3% | 9.8% | 7.4% | 52.6% |
| 8 Recovery | 91.2% | 3.6% | 8.3% | 52.3% |
| 9 Recovery | 100.6% | 3.6% | 10.1% | 62.7% |
| 10 Recovery | 99.9% | 2.2% | 10.2% | 65.9% |
| 11 Recovery | 111.0% | 4.2% | 7.9% | 71.5% |
| 12 Recovery | 110.5% | 6.3% | 12.8% | 78.9% |

The results of the test were calculated for total amount of tin recovered in the leach liquor, and the removal rate of impurities from the solid feed to the leach liquid. The removal rate is shown as a weighted average of the removal of Sb, As and Fe. FIG. 12-13 show the results of the DOE matrix shown for Sn recovery in the leach liquid and the selected impurity removal. The results are represented to show the parameters that seemed to have the biggest impact on the dissolution of the material. Both sets of results show that with increasing temperature the total amount dissolved increased. The slurry density is shown in FIG. 12-13 as the different series colors, indicating that increasing slurry density decreased the recovery of the material into the leach liquid.

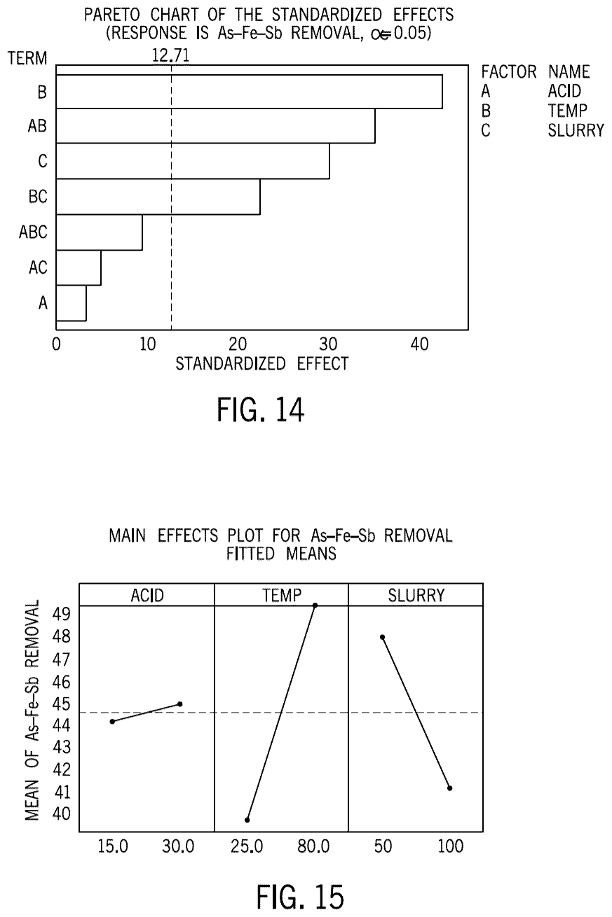

This pareto chart shows again the parameters and the interaction of parameters that have a statistical impact on the response variable. Anything that is calculated to have an effect above the significant value (shown 12.71 in FIG. 14) has a statistical impact on the results. This shows again the parameters that have an impact are temperature of the leach and slurry density. The interactions of temperature and slurry density also show to have an impact. Acid concentration and temperature was also shown, but due to the large effect of the temperature this is probably due to just the large temperature impact. This optimized leach was shown to be at room temperature, low slurry density, and low acid concentration.

Acid and temperature show a strong compound relationship, but it is a result of the large effect temperature has on the leach as shown in FIG. 15.

The leach solution is next diverted to a precipitation and liquid solid separation.

In the precipitation and liquid solid separation a lead and tin cake is formed dried, briquetted and returned to the rotary furnace.

A SCRUM Filter Cake composed of Sb, Zn, Cu, Cd is available to be processed for recovery. In some embodiments, further processing may be performed by a second or external customer.

The liquid may be routed to a wastewater treatment plant for processing after solid removal.

This is an infrequent, intermittent process to relieve elevated concentrations of As, Cd, Cu, Fe, Sb, Se, and Zn in the Pb and Sn recovery process.

### Example 3—Tin and Lead Separation by Vacuum Distillation

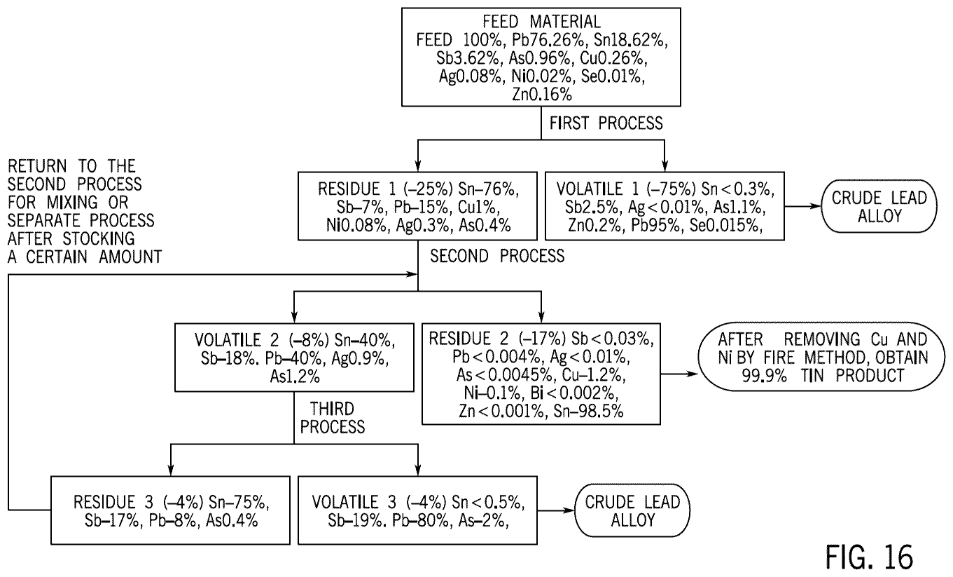

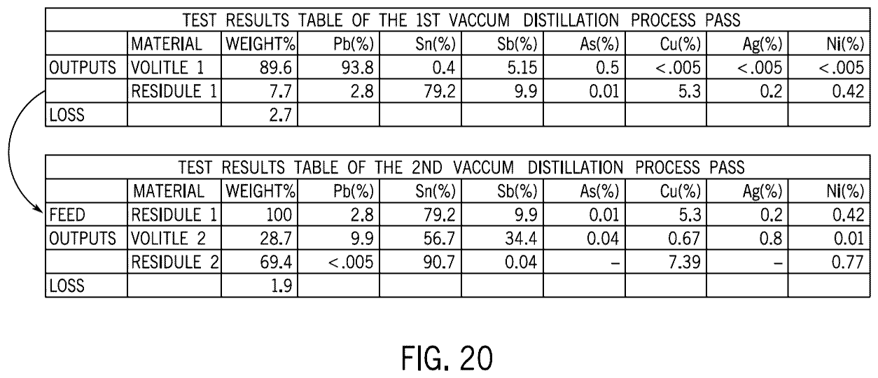

To create a concentrate tin alloy at 99.9% min Sn, a refining process of the bullion is used to remove copper and nickel followed by vacuum distillation (VDU). The concentration of sodium in the offgas produced from processing the silica-sodium-lead slag is sufficient to refine the offgas, e.g., separate the tin and lead from impurities such as copper and nickel. For example, after processing of the silica-sodium-lead slag, sodium does not need to be added or removed from the offgas produced to further refine the offgas. For example, with a total weight percent of sodium in the offgas of about 5.4%, the offgas can be refined to separate the tin and lead from impurities without varying or modifying the total weight percent of sodium in the offgas. Thus, in some embodiments, a sufficient concentration of sodium is about 5%, or from about 1% to about 10%, for example greater than about 1%, 2%, 3%, 4%, 5%, 6%, 7%, 8%, or 9%, and less than about 10%, 9%, 8%, 7%, 6%, 5%, 4%, 3%, or 2%, for example between 4% and 6%, for example about 5% for example about 5.4%. VDU separates the lead and minor residual elements after the fume dust bullion is refined. FIG. 16 represents the flow chart of the VDU process. Since the volatilization temperature of copper and nickel is close to that of tin, copper and nickel are eventually concentrated with tin during vacuum distillation. Thus, in some embodiments, for example full-scale SCRUM production, an impurity removal kettle may accompany the VDU. In other embodiments, a pre-refining step may be included to help increase the grading of recovered tin from the VDU. In some embodiments, tin grading without a pre-refining step may be about 90.7%, while grading of about 98.5% may be achieved when a pre-refining step is included. In some embodiments, post-refining of the VDU tin may further increase tin grading, for example removing additional impurities resulting in a >99.9% tin alloy. FIG. 20 represents the VDU chemistry without refining the pre-refining step. In this example, the “Loss” material referenced in the Weight % column is at least partially due to adherence to the insulation material in the distillation process when batched. However in other examples, such as in full-scale continuous units, this loss does not occur.

### Example 4—Slag—Commercializing Cleaned Slag Product—3D Mortar Printing and Casting Pavement Tiles

Slag is granulated using air and/or water and made into a slurry mortar via a binder/activator [such as Metakaolin (MK; Al—Si), limestone (LS; CaCO3), Alkali salts (mainly Na) (Na2CO3 (Nc), Na2SO4 (N$)), NaOH (NH), Na-silicate (NS)]. Controlling the TBRC slag to retain the high concentrations of sodium, provides benefits of a natural binder/activator in the slurry. This reduces the amount of additives needed to meet specifications for use. This mortar has multiple uses in structural applications or design applications and uses 5× less cement than typical mortars resulting in approximately 80% less CO2 production. The strength of the mortar projections matches that of current commercial produced mortars. These mortar products allow for efficient construction customization and complexity in building systems, while reducing CO2 footprint. Leaching results from column tests have shown nonhazardous solids. The mortar can be 3D printed or casted into different types of monolithic construction materials (dense or porous).

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

All references disclosed herein, whether patent or non-patent, are hereby incorporated by reference as if each was included at its citation, in its entirety. In case of conflict between reference and specification, the present specification, including definitions, will control.

Although the present disclosure has been described with a certain degree of particularity, it is understood the disclosure has been made by way of example, and changes in detail or structure may be made without departing from the spirit of the disclosure as defined in the appended claims. For example, in methodologies directly or indirectly set forth herein, various steps and operations are described in one possible order of operation but those skilled in the art will recognize the steps and operation may be rearranged, replaced or eliminated without necessarily departing from the spirit and scope of the present disclosure. It is intended that all matter contained in the above description or shown in the accompanying drawings shall be interpreted as illustrative only and not limiting. Changes in detail or structure may be made without departing from the spirit of the present disclosure as defined in the appended claims.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions. Every range of values (of the form, “from about a to about b,” or, equivalently, “from approximately a to b,” or, equivalently, “from approximately a−b” or, equivalently, “greater than about a and less than about b”, for example) disclosed herein is to be understood to set forth every number and range encompassed within the broader range of values. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1. A method for processing a silica-sodium-lead slag, the method comprising:
obtaining the silica-sodium-lead slag;
placing the silica-sodium-lead slag into a furnace;
heating the silica-sodium-lead slag to produce:
an offgas containing tin and lead, and
a reduced metals sodium rich slag;
collecting at least a portion of the offgas; and thereby
reducing the tin and lead content of the silica-sodium-lead slag to produce the reduced metals sodium rich slag.

2. The method of claim 1, wherein the heating step increases the temperature of the silica-sodium-lead slag to at least about 1400° C. and less than about 1500° C.

3. The method of claim 1, wherein the collecting is via one or more cartridges and baghouses.

4. The method of claim 1, wherein the silica-sodium-lead slag is lead blast furnace slag.

5. The method of claim 1, wherein the silica-sodium-lead slag comprises greater than 5 ppm lead.

6. The method of claim 1, wherein the offgas comprises sodium.

7. The method of claim 1, wherein the offgas comprises sodium with a total weight that is about ¼ the sodium in the reduced metals sodium rich slag.

8. The method of claim 1, wherein the total weight of lead in the offgas is at least 100-fold greater than in the reduced metals sodium rich slag.

9. The method of claim 1, wherein the furnace is a top blown rotary furnace.

10. The method of claim 1, wherein the collected offgas is further subjected to processing in a furnace.

11. The method of claim 1, wherein the collected offgas is further subjected to processing via a sulfuric acid leaching process.

12. The method of claim 1, wherein after the silica-sodium-lead slag is heated, a total recovered weight is partitioned with the total weight percent of the offgas greater than about 2% and less than about 6% and the total weight percent of the reduced metals sodium rich slag greater than about 94% and less than about 98%.

13. The method of claim 1, wherein:
the offgas comprises sodium;
the total weight of the sodium in the offgas is greater than about 1% and less than about 10% of the total weight of the offgas; and
the total weight of the sodium in the reduced metals sodium rich slag is greater than about 5% and less than about 15% of the total weight of the reduced metals sodium rich slag.

14. The method of claim 1, wherein:
the reduced metals sodium rich slag comprises lead;
the total weight of the lead in the offgas is greater than about 35% and less than about 50% of the total weight of the offgas; and
the total weight of the lead in the reduced metals sodium rich slag is greater than about 0.01% and less than about 0.1% of the total weight of the reduced metals sodium rich slag.

15. The method of claim 1, wherein:
the reduced metals sodium rich slag comprises tin;
the total weight of the tin in the offgas is greater than about 5% and less than about 15% of the total weight of the offgas; and
the total weight of the tin in the reduced metals sodium rich slag is greater than about 0.01% and less than about 0.1% of the total weight of the reduced metals sodium rich slag.

16. The method of claim 1, further comprising:
refining the offgas to separate the tin and the lead from impurities; and
refining a recycled tin dross with the offgas.

17. The method of claim 16, wherein the offgas comprises a total weight percent of sodium greater than about 1% and less than about 10%, and may be used to refine the offgas.

18. A composition comprising the reduced metals sodium rich slag of claim 1.

19. The composition of claim 18 for use as waste filler in one or more of product manufacturing processes.

20. (canceled)

21. A slag material comprising:
sodium, at greater than about 5% and less than about 15% of the total weight of the slag material;
lead, at greater than about 0.01% and less than about 0.1% of the total weight of the slag material; and
tin, at greater than about 0.01% and less than about 0.1% of the total weight of the slag material.
